(19) United States
(12) Patent Application Publication
(10) Pub. No.: US 2017/0043465 A1
(43) Pub. Date: Feb. 16, 2017

(54) HAND-HELD POWER TOOL

(71) Applicant: Hilti Aktiengesellschaft, Schaan (LI)

(72) Inventors: Manfred Schallert, Nenzing (AT); Manfred Ludwig, Landsberg (DE); Erwin Manschitz, Germering (DE); Horst Stroissnigg, Puergen (DE); Werner Kaibach, Kaufering (DE); Franz Moessnang, Stadbergen (DE)

(21) Appl. No.: 15/305,978

(22) PCT Filed: Apr. 1, 2015
(86) PCT No.: PCT/EP2015/057158

§ 371 Date: Oct. 21, 2016

(30) Foreign Application Priority Data
Apr. 22, 2014 (EP) 14165357.6

(51) Int. Cl. B25D 16/00; F16D 7/00

(52) U.S. Cl. CPC B25D 16/003; F16D 7/00

(57) ABSTRACT

A hand-held power tool 1 has a tool socket 2 to hold a tool 4 on a working axis 11, a motor 5 and a pneumatic striking mechanism 6. A driven shaft 7 is coupled to the tool socket 2 in order to rotate the tool around the working axis 11. A slip clutch 24 is arranged in the drive train between the motor 5 and the driven shaft 7. The slip clutch 24 has a disk 25 on the drive side and a disk 26 on the driven side. On a driving ring surface 28 that is in contact with the disk 26 on the driven side, the disk 25 on the drive side has first sectors 33 that have a high friction value as well as second sectors 34 that have a low friction value. On the driven ring surface 29 that is in contact with the driving ring surface 28, the disk 26 on the driven side has third sectors 35 that have a high friction value as well as fourth sectors 36 that have a low friction value.

### FIELD OF THE INVENTION

The present invention relates to a hand-held power tool for rotating tools, especially for a power drill or a hammer drill.

By way of example, a hammer drill is known from U.S. Pat. No. 5,954,457 A. The hammer drill has a pneumatic striking mechanism that is based on an exciter piston that is moved back and forth by means of a motor and based on a striking piston that is coupled to the exciter piston via a pneumatic spring. In addition to striking, a drill can also be rotated around its axis by means of a rotary drive. An overload clutch separates the rotary drive from the motor. The overload clutch is integrated into a hollow pinion. A shaft situated on the motor side is provided with spring-loaded latching elements that engage with a positive fit into the pinion in the radial direction.

### SUMMARY OF THE INVENTION

The present invention provides a hand held power tool including a tool socket (2) to hold a tool (4) on a working axis (11), a motor (5) and a pneumatic striking mechanism (6). A driven shaft (7) is coupled to the tool socket (2) in order to rotate the tool around the working axis (11). A slip clutch (24) is arranged in the drive train between the motor (5) and the driven shaft (7). The slip clutch (24) has a disk (25) on the drive side and a disk (26) on the driven side. On a driving ring surface (28) that is in contact with the disk (26) on the driven side, the disk (25) on the drive side has first sectors (33) that have a high friction value as well as second sectors (34) that have a low friction value. On the driven ring surface (29) that is in contact with the driving ring surface (28), the disk (26) on the driven side has third sectors (35) that have a high friction value as well as fourth sectors (36) that have a low friction value.

The slip clutch permits a very compact structure with a small number of individual construction elements, which facilitates the assembly.

### BRIEF DESCRIPTION OF THE DRAWINGS

The description below explains the invention on the basis of embodiments and figures given by way of examples. The figures show the following:

FIG. 1 a hammer drill,

FIG. 2 a slip clutch,

FIG. 3 a disk of the slip clutch in a top view,

FIG. 4 a disk of a slip clutch in a top view,

FIG. 5 a slip clutch,

FIG. 6 a disk of the slip clutch in a top view.

Unless otherwise indicated, the same or functionally identical elements are designated in the figures by the same reference numerals.

### DETAILED DESCRIPTION

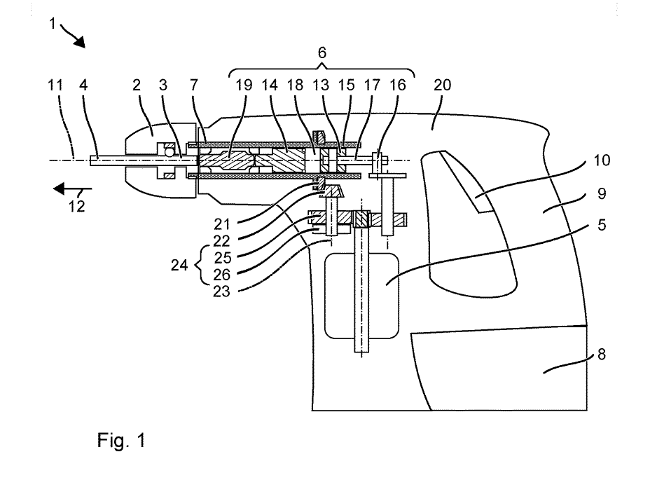

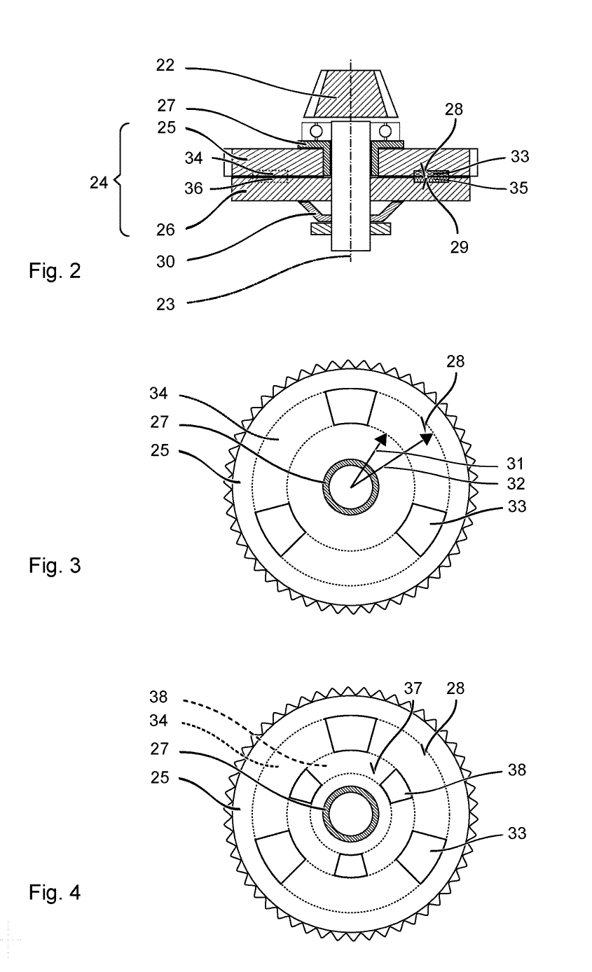

FIG. 1 schematically shows a hammer drill 1 as an example of a handheld chiseling power tool. The hammer drill 1 has a tool socket 2 into which one shank end 3 of a tool, for example, a drill bit 4, can be inserted. The primary drive of the hammer drill 1 is in the form of a motor 5 which drives a striking mechanism 6 as well as a driven shaft 7. A battery pack 8 or a mains line supply the motor 5 with power. The user can guide the hammer drill 1 by means of a handle 9 and can start up the hammer drill 1 by means of a system switch 10. During operation, the hammer drill 1 continuously rotates the drill bit 4 around the working axis 11 and, in this process, it can cause the drill bit 4 to strike into a substrate in the striking direction 12 along the working axis 11.

The striking mechanism 6 is a pneumatic striking mechanism 6. An exciter piston 13 and a striker 14 are installed movably along the working axis 11 in a guide tube 15 in the striking mechanism 6. The exciter piston 13 is coupled to the motor 5 via an eccentric 16 and it is forced to execute a periodical, linear movement. A connecting rod 17 connects the eccentric 16 to the exciter piston 13. A pneumatic spring that is formed by a pneumatic chamber 18 between the exciter piston 13 and the striker 14 couples a movement of the striker 14 to the movement of the exciter piston 13. The striker 14 can strike a rear end of the drill bit 4 directly or it can transmit some of its pulse to the drill bit 4 indirectly via an essentially stationary intermediate striker 19. The striking mechanism 6 and preferably the additional drive components are arranged inside a machine housing 20.

The driven shaft 7 is preferably a hollow tube that makes a transition to the guide tube 15. A bevel gear 21 is arranged coaxially on the driven shaft 7. The bevel gear 21 can be non-rotatably connected to the driven shaft 7 by means of a press fit or by a gear. A pinion 22 meshes with the bevel gear 21. The pinion 22 rotates around an axis of rotation 23. Between the pinion 22 and the motor 5, there is a slip clutch 24 that briefly interrupts the transmission of a torque during an overload situation. The slip clutch 24 has a disk 25 on the drive side and a disk 26 on the driven side, both of which rotate, for instance, around the same axis of rotation as the pinion 22. The disk 25 on the drive side is, for example, a gear wheel with a set of end face teeth that mesh with a gear wheel situated on the motor shaft. The disk 25 on the drive side is uncoupled from the pinion 22 by means of a sleeve 27. The disk 26 on the driven side is non-rotatably connected to the pinion 22.

The disk 25 on the drive side has an active side with a ring surface 28. The disk 26 on the driven side likewise has an active side with a ring surface 29. The two active sides touch each other, especially the two ring surfaces 28, 29. A spring 30 is positioned in such a way that the two ring surfaces 28, 29 are permanently in contact. Preferably, neither the disk 25 on the drive side nor the disk 26 on the driven side is movable along the axis of rotation 23.

The ring surface 28 of the disk 25 on the drive side is shown in FIG. 3 in a top view. The ring surface 28 has an inner radius 31 and an outer radius 32. The ring surface 28 given by way of example has three first sectors 33 that are provided with a rubber texturing. The first sectors 33 preferably each cover an angle of less than 45° as seen from the axis of rotation 23. The three first sectors 33 are distributed symmetrically around the axis of rotation 23. The remaining other three second sectors 34 are preferably smooth steel surfaces.

The ring surface 29 of the disk 26 on the driven side is preferably designed in the same manner as the ring surface 33 of the disk 25 on the drive side. An inner radius and an outer radius of the ring surface 29 are the same as the opposite ring surface 33, so that they touch each other. The ring surface 29 on the driven side likewise has three (third) sectors 35, which are rubber-textured. Their dimensions are preferably equal to those of the first sectors 33. The remaining (fourth) sectors 36 are preferably smooth steel surfaces. The slip clutch 24 remains engaged as long as the rubber-textured first and third sectors 33, 35 are resting on each other. The contact pressure of the spring 30 increases the adhesion of the two sectors 33, 36. As soon as the adhesive force is exceeded by the applied torque, the driving disk 25 slips and the first sectors 33 increasingly overlap and finally exclusively with the fourth sectors 36. The driving disk 25 can now be rotated virtually without torque vis-à-vis the driven disk 26. Accordingly, the motor 5 accelerates. The large angle of preferably more than 75° between the first sectors 33 permits a long acceleration phase. The motor 5 can generate a high torque peak, for example, in order to release a drill bit 4 that, at a lower static torque, can no longer be rotated, and triggers the slip clutch 24.

In a preferred embodiment, the ring surfaces 28, 29 have three, two or preferably only one first or third sector 33, 35. The sectors 33, 35 occupy between 25% and 40% of the ring surface 29 in order to provide a sufficient adhesion for the transmission of a torque.

FIG. 4 shows another embodiment in which the driving disk 25 has two concentric ring surfaces 28, 37. The two ring surfaces 28 do not overlap. Both ring surfaces 28, 37 each have first sectors 33, 38 with a rubber texturing and second sectors 34, 38 with a smooth steel surface. The first sectors 33 of the outer ring surface 28 are preferably offset vis-à-vis the sectors 38 of the inner ring surface 37 by half of the angle between the first sectors 33 of the outer ring surface 33.

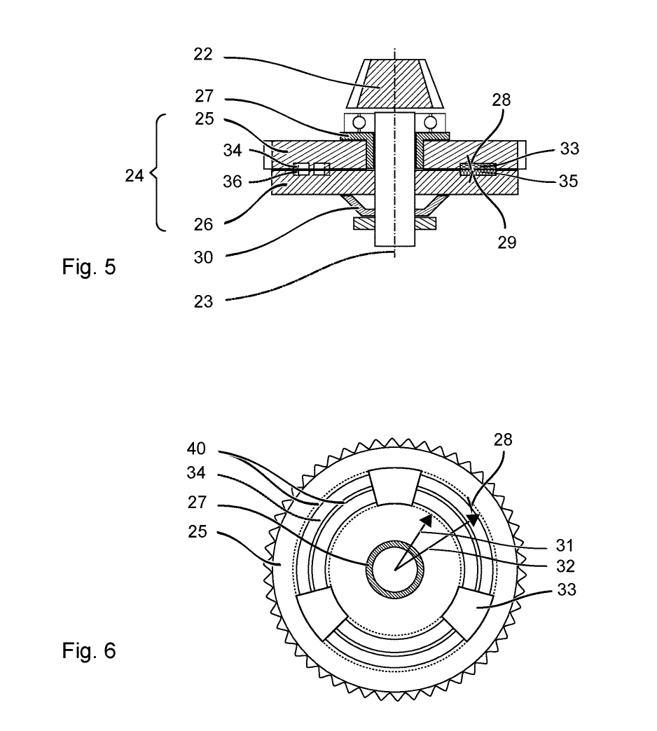

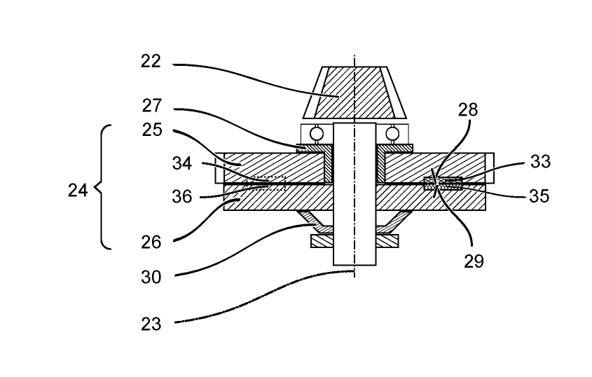

FIGS. 5 and 6 show another embodiment in which the second sectors 34 comprise one or more circular webs 40 that are concentric to the axis 23. The covering surfaces of the webs 40 are in one plane with the ring surface 28. Between the webs 40, there is a corresponding concentric groove. The first sectors 33 touch the ring surface 29 of the driven disk 26 completely and the second sectors only touch it via the webs 40. The driven disk 26 can be configured identically to the driving disk 25.

What is claimed is:

1-6. (canceled)

7. A hand-held power tool comprising:
a tool socket to hold a tool on a working axis;
a motor;
a pneumatic striking mechanism;
a driven shaft coupled to the tool socket to rotate the tool around the working axis;
a slip clutch arranged in a drive train, the slip clutch being between the motor and the driven shaft;
the slip clutch having a drive side disk and a driven side disk;
on a driving ring surface in contact with the driven side disk, the drive side disk having first sectors having a higher friction value as well as second sectors having a lower friction value than the first sectors; and,
on a driven ring surface contact with the driving ring surface, the driven side disk has third sectors having a higher friction value as well as fourth sectors having a lower friction value than the third sectors.

8. The hand-held power tool as recited in claim 7 further comprising a spring holding the driving ring and driven ring surfaces in permanent contact.

9. The hand-held power tool as recited in claim 7 wherein that the first sectors are provided with a rubber texturing, and the second sectors have a polished steel surface.

10. The hand-held power tool as recited in claim 7 wherein the driving ring and driven ring surfaces each have a maximum of three first sectors and third sectors, respectively.

11. The hand-held power tool as recited in claim 10 wherein the first and third sectors cover one-fourth to one-third of the driving ring and driven ring surfaces, respectively.

12. The hand-held power tool as recited in claim 7 wherein the second sectors have webs concentric to the working axis and in one plane with the first sector.
